(19) United States
(12) Patent Application Publication
(10) Pub. No.: US 2009/0267452 A1
(43) Pub. Date: Oct. 29, 2009

(54) SYSTEM AND METHOD FOR ENERGY GENERATION IN AN OIL FIELD ENVIRONMENT

(75) Inventor: Raed H. Abdallah, Houston, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: vMonitor, Inc., Houston, TX (US)

(21) Appl. No.: 12/108,620

(22) Filed: Apr. 24, 2008

(51) Int. Cl. H02N 2/18

(52) U.S. Cl. 310/319

(57) ABSTRACT

A system and method for power generation in an oil field environment is disclosed.

### BACKGROUND

1. Field of the Disclosure

The field of the present disclosure relates to energy generation in an oil field environment.

2. Background

The exploitation of hydrocarbon reserves includes several phases including production and processing at a well site. Well site activities include monitoring of several parameters of the well site to ensure safety at the site and surrounding areas and to ensure the produced hydrocarbon products, either at the raw product stage or during or after well site processing, have a desired quality.

Information obtained by well site monitoring is used by well site personnel and by off-site personnel and customers for various purposes, including control of the well site and recording various production and well site parameters. In remote locations where power is scarce alternative power sources are used to power wireless (or none wireless) devices. Traditionally Solar power has been used as such power source. Another, alternative for Solar is the use of piezoelectric material to convert energy generated by vibration into power. The use of such material to harvest vibration energy allows for battery-less operation, extended rechargeable battery life and maintenance free telemetry.

### SUMMARY

A system and method are disclosed for generating energy from vibration energy and from contraction and expansion energy.

### BRIEF DESCRIPTION OF THE DRAWINGS

For detailed understanding of the present disclosure, references should be made to the following detailed description of the several illustrative embodiments, taken in conjunction with the accompanying drawings, in which like elements have been given like numerals and wherein:

FIG. 1 is an illustration of a power generation system in an oil field production well in an illustrative embodiment;

FIG. 2 is a schematic depiction of a device for electrical energy generation provided in an illustrative embodiment;

FIG. 3 is a schematic depiction of a power generation system in an illustrative embodiment;

FIG. 4 is a schematic depiction of a device for electrical energy generation in another illustrative embodiment;

FIG. 5 is a schematic depiction of a device for electrical energy generation in another illustrative embodiment;

FIG. 6 is a schematic depiction of a device for electrical energy generation in another illustrative embodiment;

FIG. 7 is a schematic depiction of an energy conversion device in another illustrative embodiment;

FIG. 8 is a depiction of a system for electrical energy generation in an illustrative embodiment; and

FIG. 9 is a depiction of a system for electrical energy generation in an illustrative embodiment.

### DETAILED DESCRIPTION OF ILLUSTRATIVE EMBODIMENTS

Portions of the present disclosure, detailed description and claims may be presented in terms of logic, software or software implemented aspects typically encoded on a variety of computer readable media including, but not limited to, computer-readable media, machine-readable media, program storage media or computer program product. Such media may be handled, read, sensed and/or interpreted by a computer or information processing device. Those skilled in the art will appreciate that such media may take various forms such as cards, tapes, magnetic disks, and optical disks. Examples of magnetic disks include floppy disks and hard drives, and examples of optical disks include compact disk read only memory (“CD-ROM”) and digital versatile disc (“DVD”). It should be understood that the given implementations are illustrative only and do not limit the present invention.

Some portions of the present disclosure, detailed description and claims use the term information, data, message, and these terms may be used in the singular or plural form. The term information as used herein refers to any information relating to well site monitoring and may include any one or combination of data, signal, message, command, and response, any of which may be analog or digital and may be communicated by wireless or wired transmission.

In a particular illustrative embodiment, a power generation system and one or more wireless transmitters are coupled or connected to an analog input or digital input device, such as an oil field apparatus such as a pressure sensor, communicating data to one or more wireless receivers connected to an analog output or digital output device. The power generation system, wireless transmitter and receiver can be housed in a package suited or housing for industrial areas. The housing can be a gas tight box in one embodiment. In another embodiment the wireless transmitter includes but is not limited to a main controller board, one more digital input input/output (IO) channels, one more analog input IO channels, a radio unit, and an antenna mounted to the housing and a power source (i.e. battery pack). The wireless receiver includes but is not limited to a main controller board including a processor and a computer readable medium containing data and a computer program, one more digital input IO channels, one more analog input IO channels, a radio unit, an antenna mounted on the housing and a power source (i.e., battery pack). In another embodiment a system is provided having at least one transmitter/receiver set, a number of transmitters communicating with a single receiver set, two or more sets of any combination of thereof.

In a particular embodiment, a power generation system is disclosed the system including but not limited to an electric energy generation material in contact with an external surface of a flow pipe; an electrical energy storage element in electrical communication with the electric energy generation material; and an electrical device in electrical communication with the energy storage element. In another particular embodiment, in the power generation system the electric energy generation material further includes but is not limited to a clamp mechanically fastened to the exterior surface of the flow pipe. In another particular embodiment, in the power generation system the electric energy generation material further includes but is not limited to an electric energy generation pendulum piece having a first end and a second end, wherein the first end is mechanically attached to the external surface of the flow pipe. In another particular embodiment, in the power generation system the electric energy generation pendulum piece second end is attached to a mass.

In another particular embodiment, in the power generation system the electric energy generation pendulum piece is surrounded by a housing structure. In another particular embodiment, in the power generation system the electric energy generation material further includes but is not limited to a flow meter containing the electric energy generation material. In another particular embodiment, in the power generation system the flow meter is substantially made out of the electric energy generation material. In another particular embodiment, in the power generation system the electrical device further includes but is not limited to a radio transmitter in wireless communication with a SCADA system.

In another particular embodiment, in the power generation system the electric energy generation further includes but is not limited to a piezoelectric material that generates electrical energy from vibration energy due to flow of a fluid in the flow pipe. In another particular embodiment, in the power generation system the electric energy generation further includes but is not limited to a piezoelectric material that generates electrical energy from thermal expansion and contraction of the flow pipe.

In another particular embodiment, a method is disclosed for generating power, the method including but not limited to fastening a electric energy generation material to an external surface of a flow pipe; transferring power generated by the electric energy generation material to an electrical energy storage element in electrical communication with the electric energy generation material; and transferring power from the electrical energy storage element to an electrical device in electrical communication with the energy storage element. In another particular embodiment, in the power generating method the electric energy generation material further includes but is not limited to a clamp mechanically fastened to the exterior of the flow pipe.

In another particular embodiment, in the power generating method the electric energy generation material further includes but is not limited to a electric energy generation pendulum piece having a first end and a second end, wherein the first end is mechanically attached to the external surface of the flow pipe. In another particular embodiment, in the power generating method the electric energy generation pendulum piece second end is attached to a mass. In another particular embodiment, in the power generating method the electric energy generation pendulum piece is surrounded by a housing structure. In another particular embodiment, in the power generating method the electric energy generation material further includes but is not limited to a flow meter containing the electric energy generation material. In another particular embodiment, in the power generating method the flow meter is substantially made out of the electric energy generation material. In another particular embodiment, in the power generating method the electrical device further includes but is not limited to a radio transmitter in wireless communication with a SCADA system. In another particular embodiment, in the power generating method the electric energy generation further includes but is not limited to a piezoelectric material, the method further including but not limited to generating electrical energy in the piezoelectric material from turbulent energy from vibration due to flow of a fluid in the flow pipe.

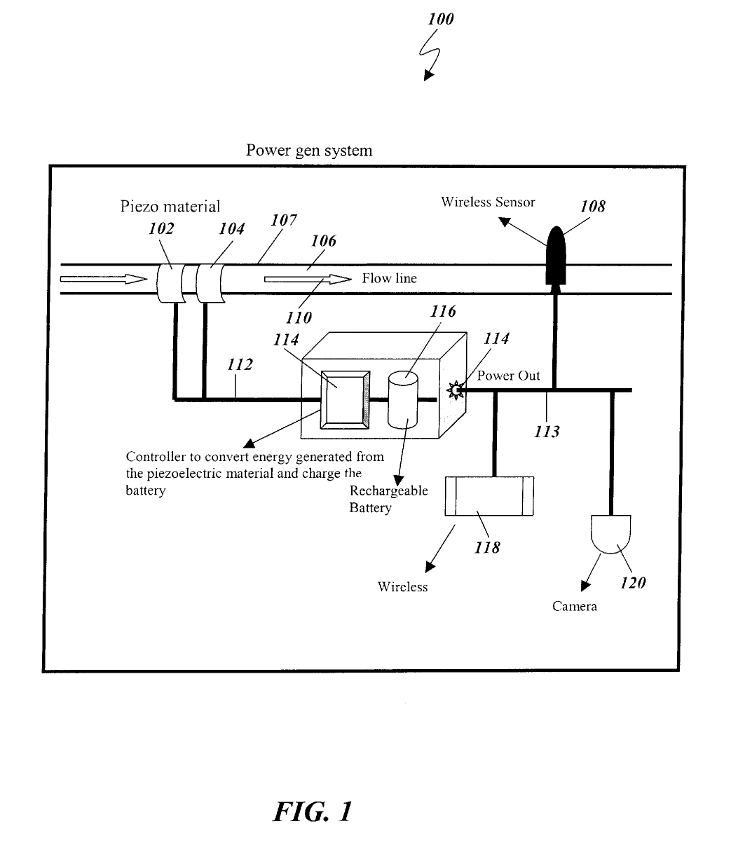

Turning now to FIG. 1 a power generation system 100 is depicted. The power generation system includes but is not limited to an electric energy generation material 102 and 104 in contact with the external surface 107 of a flow line 106. In an illustrative embodiment, the electrical energy generation material includes but is not limited to a piezoelectric material which generates energy from vibration, sound energy or expansion and contraction impinging on the piezoelectric material. The electrical energy generation material is connected by electrical conductors 112 two and electrical energy conversion device 114. The electrical energy conversion device 114 receives the electrical energy generated by the electrical energy generation material and converts it to a direct current voltage, which is stored in an energy storage device such as rechargeable battery 116. Another illustrative embodiment, the electrical energy conversion device directly supplies power to the power output 114 without storing energy in the energy storage device 116. The powerhouse from the electrical energy conversion device already electrical energy storage device is transferred via conductors 113 to electrical devices, including but not limited to a wireless sensor 108, a wireless transmitter 118 and a camera 120.

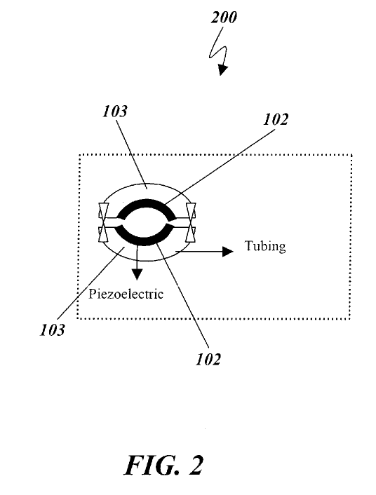

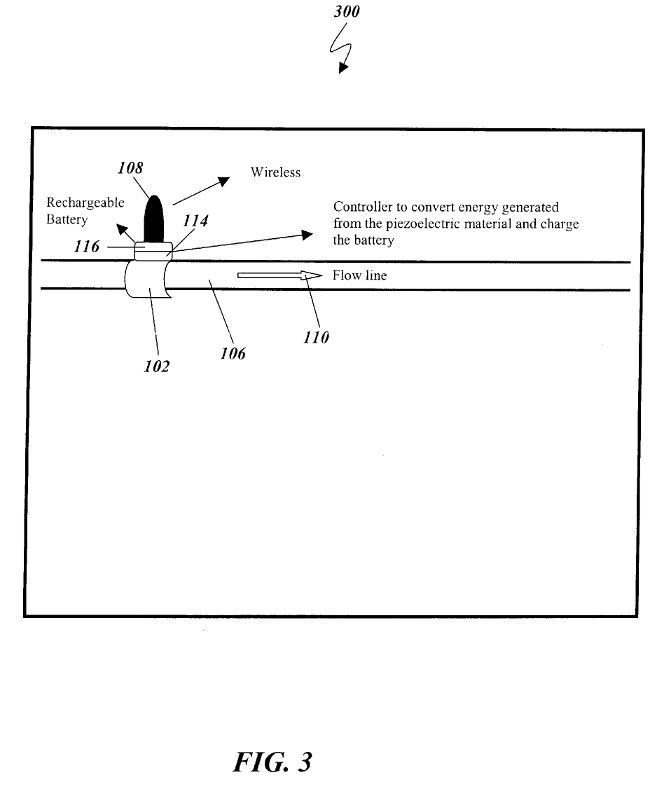

Turning now to FIG. 2, in another illustrative embodiment, electrical energy generation material 102 is fastened to flow pipe 106 via mechanical fastener 103. In a particular illustrative embodiment mechanical fastener 103 includes but is not limited to a clap mechanically fastened to the extra or service a flow pipe 106. Turning now to FIG. 3, in another illustrative embodiment, the power generation system 300 includes but is not limited to electrical energy generation material 102 surrounding exterior surface flow pipe 106 in the electrical communication with electrical energy conversion device 104 mounted on electrical energy generation material 102. A wireless electrical device 108 is in electrical communication with the electrical energy conversion device 114. In another particular illustrative embodiment, a rechargeable 116 is positioned in electrical communication with the electrical energy conversion device and supplies power to the wireless electrical device 108.

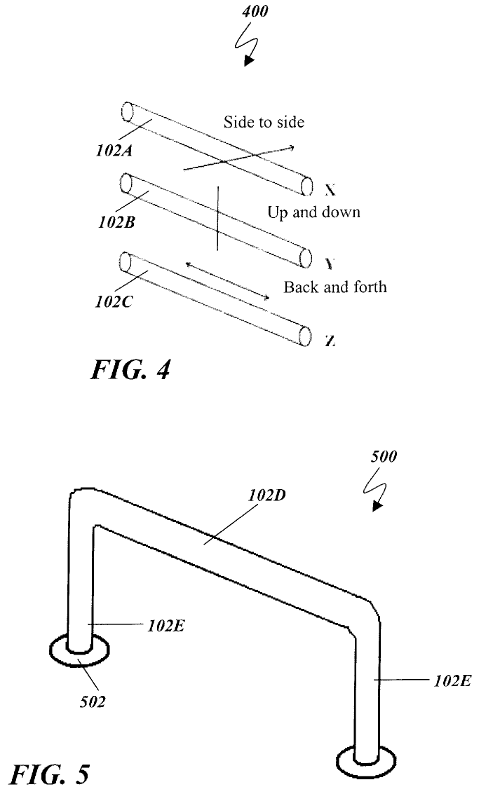

Turning now to FIG. 4, in another illustrative embodiment electrical energy generation material 102, further includes but is not limited to elongated members 102A, 102B and 102C, each of which are made up the electrical energy generation material in line with the x, y and z axes of the flow pipe 106, the x axis being parallel to direction of flow path 110 and y axis perpendicular to the x axis and the z axis perpendicular to a plane containing the x and y axes. In a particular embodiment, the longitudinal axis of the flow pipe is parallel to the direction of flow 110 and is aligned with electrical energy generation material member 102B. Electrical energy generation material member 102A is aligned transverse or perpendicular to electrical energy generation device member 102B. Electrical energy generation material member 102C is aligned transverse or perpendicular to a plane aligned containing electrical energy generation device member 102A and 102B.

Turning now to FIG. 5, in another particular embodiment, electrical energy generation material further includes but is not limited to a longitudinal member 102D, aligned with the longitudinal axis of flow pipe 106 and two transverse members 102D attached to longitudinal member 102D on one end and the up other end are attached to the exterior surface of flow pipe 106 and perpendicular to the longitudinal axis hope. The two transverse members 102E are attached to the exterior structure for so the flow pipe 106 via fasteners 502.

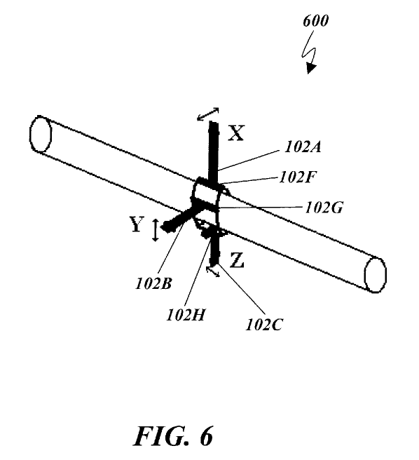

Turning now to FIG. 6, in another particular illustrative embodiment, electrical energy generation material 102 further includes but is not limited to energy generation material strips 102F, 102G and 102H. In a particular embodiment, the longitudinal axis of the flow pie is parallel to the direction of flow 110 and is aligned with electrical energy generation material member 102F. Electrical energy generation material member 102G is aligned with the direction of flow 110 but rotated 90 degrees from electrical energy generation device member 102F. Electrical energy generation material member 102H is aligned transverse or perpendicular to electrical energy generation device members 102F and 102G.

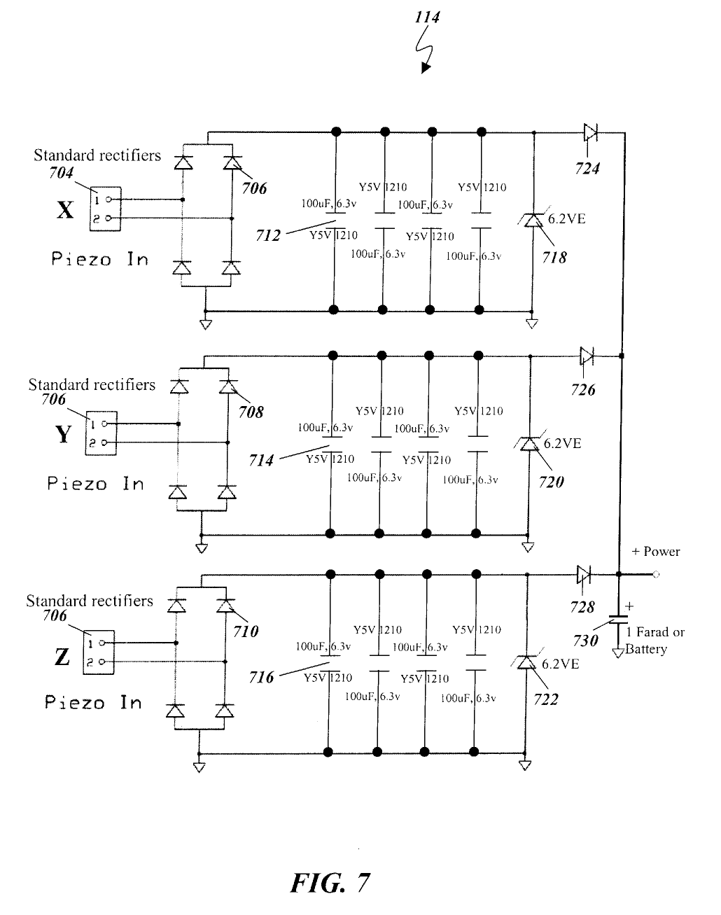

Turning now to FIG. 7, in another particular embodiment, electrical energy conversion device 114 further includes but is not limited to power input devices 704, 706 and 708. Energy from electrical energy generation device element 102A, which is aligned with the x-axis of the flow pipe, is input to input device 704. Energy from electrical energy generation device element 102B, which is aligned with the y-axis of the flow pipe is input to input device 706. Energy from electrical energy generation device element 102C, which is aligned with the z-axis of the flow pipe is input to input device 708. As illustrated in FIG. 7, power input device 704 provides power to rectifiers 706. Rectifiers 706 are in electrical communication with capacitors 712 and voltage regulator diode 718. The output from capacitors 712 and are in electrical communication with rectifier 724, which is provided to power output 114 which is electrical communication with capacitor 730.

Power input device 706 provides power to rectifiers 708. Rectifiers 708 are in electrical communication with capacitors 714 and voltage regulator diode 720. The output from capacitors 712 and are in electrical communication with rectifier 726, which is provided to power output 114 which is electrical communication with capacitor 730. Power input device 708 provides power to rectifiers 710. Rectifiers 710 are in electrical communication with capacitors 716 and voltage regulator diode 722. The output from capacitors 716 are in electrical communication with rectifier 728, which provides power output 114 which is electrical communication with capacitor 730.

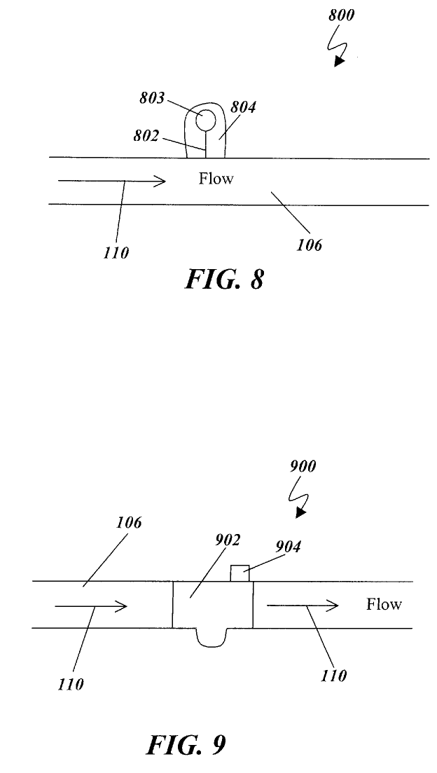

Turning now to FIG. 8 in another particular embodiment, electrical energy generation material 102 is formed as a longitudinal member attached to a mass 803 on one and an attached to surface of flow pie 106 on the other end. A housing 804 is provided to surround electrical energy generation pendulum piece 802 which acts as a pendulum to magnify the effects of vibration transmitted from the flow pipe to the electric material pendulum piece 802 and mass 803. Another particular embodiment, the housing 804 is an explosion proof housing which surrounds the electrical energy generation pendulum piece 802 mass 803 and electrical devices 114, 116, 108, 118 and 120.

Turning now to FIG. 9 in another particular embodiment of the power generation system further comprises a flow meter 902 connected in line between two sections of flow pipe 106 day in 106 the period. A housing 94 is provided it contains electronic devices including but not limited to electrical energy conversion device 114, electrical energy storage device 116, wireless device 108, wireless transmitter 118 and camera 120. The flow meter nine to his suspect substantially made up of electrical energy generation material, which responds to flow in the flow pie and or thermal contraction and expansion of the flow pipe and the flow meter itself to generate electrical energy, which transmitted to the electrical energy conversion device and the electrical devices which are in luck communication with the electrical energy conversion device.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A power generation system, the system comprising:
an electric energy generation material in contact with an external surface of a flow pipe;
an electrical energy storage element in electrical communication with the electric energy generation material; and
an electrical device in electrical communication with the energy storage element

2. The power generation system of claim 1, wherein the electric energy generation material further comprises a clamp mechanically fastened to the exterior surface of the flow pipe.

3. The power generation system of claim 1, wherein the electric energy generation material further comprises a electric energy generation pendulum piece having a first end and a second end, wherein the first end is mechanically attached to the external surface of the flow pipe.

4. The power generation system of claim 3, wherein the electric energy generation pendulum piece second end is attached to a mass.

5. The power generation system of claim 3, wherein the electric energy generation pendulum piece is surrounded by a housing structure.

6. The power generation system of claim 1, wherein the electric energy generation material further comprises a flow meter containing the electric energy generation material.

7. The power generation system of claim 6, wherein the flow meter is substantially made out of the electric energy generation material.

8. The power generation system of claim 1, wherein the electrical device further comprises a radio transmitter in wireless communication with a SCADA system.

9. The power generation system of claim 1, wherein the electric energy generation further comprises a piezoelectric material that generates electrical energy from vibration energy due to flow of a fluid in the flow pipe.

10. The power generation system of claim 1, wherein the electric energy generation further comprises a piezoelectric material that generates electrical energy from thermal expansion and contraction of the flow pipe.

11. A method for generating power, the method comprising:
fastening an electric energy generation material to an external surface of a flow pipe;
transferring power generated by the electric energy generation material to an electrical energy storage element in electrical communication with the electric energy generation material; and
transferring power from the electrical energy storage element to an electrical device in electrical communication with the energy storage element.

12. The method of claim 11, wherein the electric energy generation material further comprises a clamp mechanically fastened to the exterior of the flow pipe.

13. The method of claim 11, wherein the electric energy generation material further comprises a electric energy generation pendulum piece having a first end and a second end, wherein the first end is mechanically attached to the external surface of the flow pipe.

14. The method of claim 13, wherein the electric energy generation pendulum piece second end is attached to a mass.

15. The method of claim 13, wherein the electric energy generation pendulum piece is surrounded by a housing structure.

16. The method of claim 11, wherein the electric energy generation material further comprises a flow meter containing the electric energy generation material.

17. The method of claim 16, wherein the flow meter is substantially made out of the electric energy generation material.

18. The method of claim 11, wherein the electrical device further comprises a radio transmitter in wireless communication with a SCADA system.

19. The method of claim 11, wherein the electric energy generation further comprises a piezoelectric material, the method further comprising:
generating electrical energy in the piezoelectric material from turbulent energy from vibration due to flow of a fluid in the flow pipe.

20. The method of claim 11, wherein the electric energy generation further comprises a piezoelectric material the method further comprising:
generating electrical energy in the piezoelectric material from thermal expansion and contraction of a fluid in the flow pipe.
